(19) United States
(12) Patent Application Publication
(10) Pub. No.: US 2014/0234597 A1
(43) Pub. Date: Aug. 21, 2014

(54) Multicomponent Tapes, Films or Yarns and Method of Preparation Thereof

(71) Applicants: Femke De Loos, Sneek (NL); Fernando Eblagon, Sneek (NL)

(72) Inventors: Femke De Loos, Sneek (NL); Fernando Eblagon, Sneek (NL)

(73) Assignee: LANKHORST PURE COMPOSITES B.V., Sneek (NL)

(21) Appl. No.: 14/237,575

(22) PCT Filed: Aug. 10, 2012
(86) PCT No.: PCT/NL2012/050556

§ 371 Date: Apr. 9, 2014

(30) Foreign Application Priority Data
Aug. 10, 2011 (NL) 2007249

(51) Int. Cl. B32B 27/36; D04H 3/011; D03D 15/00; D04H 1/435; B32B 7/02; D02G 3/02

(52) U.S. Cl. CPC B32B 27/36; B32B 7/02; D02G 3/02; D03D 15/0027; D04H 1/435; D04H 3/011
USPC 428/212; 428/373; 428/480; 442/199; 442/361

(57) ABSTRACT

The invention is directed to coextruded tapes, films, yarns and the likes of polylactic acid (PLA) and methods of preparation thereof. The present invention is directed to an extruded tape, film or yarn comprising a first phase, in particular a first layer, based on PLA and a second phase, in particular a second layer, also based on PLA, but having different sealing properties, wherein the peak melt temperature or seal initiation temperature of the second layer is lower than the peak melt temperature and/or the melt seal initiation temperature of the first layer, or wherein the Vicat softening point of the second layer is lower than the Vicat softening point of the first layer.

The invention is directed to coextruded tapes, films, yarns and the likes of polylactic acid (PLA) and methods of preparation thereof.

Polylactid acid has structural formula —[—C(CH₃)—C(O)—O—]ₙ—, where n>>1. One of the key properties of PLA is that it is compostable, viz. it can break down when composted under influence of enzymatic action in the course of time in composting conditions which makes it particularly suitable for its application in disposables. Another key property is its inherent UV stability and flame retardancy. This makes the material suitable for applications such as carpets for outdoor and indoor use.

WO-A-2010/074576 describes tapes that consist essentially of PLA. These biodegradable tapes find use inter alfa in agricultural industry, in particular for tying up plants in horticulture, but also for ropes and packaging applications.

It is an object of the present invention to provide materials which may be used in other applications than tapes as such. PLA is a material that suffers from a lack of strength and toughness, which limits its applicability. The tapes described in WO-A-2010/074576 manage to keep the compostability of the material whilst giving a significant strength and toughness increase. Nevertheless, these tapes are limited to applications in one dimension, i.e. they are only usable in tension and in one direction.

One of the objects of the present invention is to extend the applicability of these known tapes into 2- and 3-dimensional products, without the drawbacks found in injected or thermoformed PLA parts such as poor strength and fracture toughness. In particular it is an object to provide PLA tapes, films, yarns and the likes that may be further processed into products of various shapes for instance by forming a fabric from them, which fabric may then subsequently be pressure molded into the desired shape. These shaped products thus obtained would be compostable.

US-A-2009/0148715 describes laminates that comprise amorphous and crystalline PLA. These known materials also comprise an ethylene-acrylaete copolymer. These materials are not biodegradable.

US-A-6 153 276 describes lactic acid based polymers, which are chemically different from PLA.

JP-A-2003/170 560 describes a laminate, wherein a base layer (A) is made of polylactate and a layer (B) is obtained by blending an anti-blocking agent and a specific biodegradable resin. Another limitation of known PLA materials is their maximum working temperature, which is generally limited to 50° C. This limits the use of these known PLA materials in for instance disposables for catering and food service, an application that could otherwise benefit from the compostability of PLA. Thus another object of the invention is to provide a material that can be employed at higher temperature without deforming or other loss of functionality.

The present inventors found that in order to meet at least part of the above-mentioned and other objects, the PLA products should be composed of woven or wound tapes, films or yarns that are composed of at least two phases, each phase comprising a different type of PLA, in particular PLA compositions that differ with respect to their softening behavior, in particular with respect to their softening temperature as defined by the Vicat test under ISO 306, their seal initiation temperature and/or their (lowest) peak melt temperature. These phases could be separated in two layers by a co-extrusion process or could be mixed in a single layer. Thus in a first aspect, the present invention is directed to an extruded tape, film or yarn comprising a first phase, in particular a first layer, based on PLA and a second phase, in particular a second layer, also based on PLA, but having different sealing properties.

These differences in sealing properties may be expressed as follows: in accordance with the invention the second layer should have a seal initiating temperature as measured by ASTM F88 that is lower than the peak melting temperature of the first layer. The peak melting temperature is determined by differential scanning calorimetry (DSC), for instance when heated at a heating rate of 10° C./min and is the first peak (i.e. at the lowest temperature) at which the material starts to melt. For some materials it is not possible to determine a peak melting temperature, because the DSC curve shows a broad shoulder or plateau. In those cases the seal initiating temperature of the first layer may also be used, so that the seal initiating temperature of the second layer is lower than that of the first layer.

Alternatively, the differences in sealing properties between the first and second layer may be expressed as differences in the Vicat softening point as defined by ISO 306, so that in accordance with another embodiment of the invention the second layer should have a Vicat softening point that is lower than the Vicat softening point of the first layer. The Vicat softening point is the temperature at which a specimen is penetrated to a depth of 1 mm by a flat-ended needle with a 1 square mm circular or square cross-section with a load of 10 N. The second phase can be coextruded on said first phase as separate layers. Alternatively, both phases can be extruded as a single layer containing both phases. In accordance with the invention, the melt temperature or functionality of the PLA in the first phase differs from that in the second phase.

The PLA material used in the present invention for both phases, consist preferably of more than 95 wt. % PLA, more preferably more than 98 wt. %. The composition of each of the phases can be modified by the addition of other resins and additives such as functional additives like melt strength enhancers, UV-absorbents, barrier enhancers, crystallization promoters or hinderer, chain-extenders, flame retardants, fillers, plasticizers, blowing agents, compatibilizers, heat stabilizers, lubricants, antimicrobials, antioxidants, anti-static agents, thougheners, pigments, release aids or clarifying agents.

The materials of the present invention and the objects made from it are biodegradable, which means that they break down through the action of a naturally occurring microorganism, such as bacteria, fungi, etc. over a period of time. In addition, the materials and objects of the present invention are preferably also compostable, which means that they can biodegrade at a sufficiently high rate, for instance at the same rate as paper, or faster.

In the embodiment where the phases are present as separate layers, it is preferred that the tape, film or yarn has an inner layer and an outer layer, wherein predominantly the outer layer is in contact with the surroundings, so that when woven or twined, predominantly the outer layer of one tape, film or yarn (and not, or only to a small extent the inner layer) will be in contact with the outer layer of other tape(s), film(s) or yarn(s). The outer layer may then be chosen to have excellent sealing properties, whereas the inner layer may be optimized for mechanical strength. The outermost layer then acts as a glue.

In addition to or instead of being chosen for enhancing adhesive properties, the outer layer could also be chosen to improve other properties of the resulting material, for instance by choosing an outer layer composed of the PLA composition that has a high abrasion resistance or low coefficient of friction so as to improve the tribological properties of the resulting product.

The second layer (for instance the outer layer) may comprise an amorphous PLA or PLA with a lower crystallinity than the first layer. Typically amorphous PLA has a lower softening temperature (or seal initiating temperature, or peak melt temperature) than crystalline PLA.

The first layer (in particular the core layer) may comprise semi-crystalline or crystalline PLA. This may be produced for instance using a high optical purity PLLA, preferably with a D-lactic content lower than 6 wt %, or using stereocomplex PLA (sc-PLA) or stereoblock PLA (sb-PLA). Typically the crystallinity is about 25% or more, preferably more than 45%, as calculated from the measured density of the tapes and known densities of the crystalline phases (1.285 g/cm³ for the alpha polymorph, 1.301 for the beta polymorph and 1.245 g/cm³ for the amorphous phase). The ratio between the alpha and beta polymorph of the crystalline phase, whenever the beta polymorph is present, can be measured both by wide angle x-ray diffraction (WAXD) or infra-red spectroscopy (IR). This embodiment, whilst being mostly composed of a load-bearing crystalline phase, will not melt until reaching the onset of melting, which can be very high, e.g. higher than 100° C., e.g. around 140° C., thus allowing the material to be used with hot food and drinks.

Upon heating, amorphous PLA starts to soften as soon as the material reaches its glass transition temperatures (Tg). This can be observed by a sudden drop in storage modulus from 3000 MPa just before the Tg (about 55° C.) to about 5 MPa at the seal initiation temperature (80° C.). At this temperature the amorphous PLA can effectively form seals. The failure mode of the seal will determine the ability of the woven co-extruded tapes to form a solid upon hot-pressing or hot-forming and depends on the sealing temperature, the mechanical and thermal properties of the load-bearing layer and the pressure and time applied during sealing. The possible failure modes of the seal are peeling, delamination, tearing or a combination of delamination and tearing. The most likely failure modes of the seal of the current embodiment, due to the high strength of the semi-crystalline phase, are peeling and delamination. At the sealing temperature, the PLA semi-crystalline layer will soften with a reduction of the storage modulus (G′) from about 3000 MPa to about 500 MPa or about two times the stiffness of low density polyethylene at room temperature. The sealing temperature of the amorphous phase also matches the temperature for initiation of fast crystal growth for PLA which will in place improve the crystallinity and thermal and mechanical properties of the load-bearing layer. The range of melt temperature (Tm) desired for the first layer for application with hot food and drinks is preferably over 96° C., which can be achieved by a combination of heat and stress-induced crystallization and/or the choice of nucleating agents. The Tm of the semi-crystalline phase goes then well beyond the 2005 FDA code guidelines for foodservice, which requires temperatures for hot foods of 60° C. and over the maximum temperature of water-based hot drinks. Semi-crystalline PLA has a reduction of its storage modulus at 100° C. which has been reported in the literature to be between one and two orders of magnitude lower than that measured at room temperature, depending on the crystallization level. This leads to an elastic modulus of 30 MPa to 300 MPa. The materials of the present invention show a reduction in its storage modulus, as measured at room temperature, of an order of magnitude when heated up to 100° C., for instance 0.68 GPa.

The tape, film or yarn of the invention can be designed to produce excellent properties with respect to sealing. When such tapes, films or yarns are processed into a fabric, which is then subsequently processed in a pressure mold, a product is obtained with excellent mechanical properties, while maintaining its biodegradable properties in particular excellent stiffness as expressed by the E-modulus and improved fracture toughness as expressed by the increase in elongation at failure viz. injected or otherwise molded or extruded sheets or films. Further, a product is obtained which complies with food contact regulations.

The tapes, films, or yarns and the like comprising this PLA may be stretched. Preferably stretching is carried out at a total draw ratio of more than 1:4. Stretching to a draw ratio of more than 1:4 in one stretching step is not always possible and may lead to insufficient mechanical properties or an unstable process. Therefore, preferably the stretching to a total stretch ratio can be carried out in more than one stretching step, wherein in the first stretching step the draw ratio is below 1:4 and the second or further stretching step is carried out such that a total draw ratio of more than 1:4 is obtained, more preferably more than 1:5. Generally it is preferred to keep the total draw ratio below 1:14, preferably below 1:8. By carrying out the stretching step whitening of the PLA material is observed. This is indicative of an increased strength. By carrying out the stretching in a multistage stretching step excellent control of the material's properties can be obtained. In view of mechanical properties it is preferred to carry out the stretching until whitening is observed. Typically this is the case at stretch ratios of 1:5 or more.

As mentioned above, the tapes, films or yarns or the likes of the present invention may be provided with improved sealing properties. In order to make a 2-dimension or 3-dimension product out of tapes, films or yarns, these have to be glued to one another. This could be achieved through a controlled melting of the amorphous phase in the tapes, through a localized premelting of the crystalline phase, via melting of the crystalline phase or via the use of a glue. The glue could be applied as a film between the tapes or woven fabric, via a casting process or as a co-extruded layer. The solution in the current invention describes a co-extruded layer wherein there is a net reduction in the number of operations needed to make the parts and the waste associated. The other solution found to satisfy the requirements for a commingled product are the use of a partially crystallized PLA material. This can be obtained either via a modification of the processing conditions, addition of additives or resins that hamper the crystallization or increasing the D-lactide content of the PLA used, which will result in a tape or yarn with a crystalline phase and an amorphous phase.

The sealing ability of the products described in the current invention can be quantified by means of the seal initiation temperature, which may be determined according to ASTM F1921. In this test method, a tape is folded in the length and sealed to itself. Then it is cooled by air. After cooling the two sealed ends are separated again by pulling at constant speed and the seal strength is determined by measuring the seal strength in N and determining the amount of work (in mJ) to separate the entire sealed surface. The procedure is as follows. The film sample is fixed in an upper specimen grip which is connected to a load cell and a lower specimen grip which is connected to a peeling actuator. The film sample is inserted between the sealing bars by means of a specimen insertion mechanism. A seal is made. At the end of the sealing time, and after a preset delay time, the peeling actuator moves down with a preset speed and peels the hot seal totally apart.

The invention is directed to PLA “tapes, films or yarns (or the likes)” viz. any shape that is characterized by a length that is considerably longer than its thickness. Typically the tape, film or yarn product is a string-shaped object having a length that is more than 100 times its thickness. For instance, a typical reel may comprise ca. 5000 m of tape film or yarn having a thickness of 0.1 mm or less. The tape film or yarn may also be twisted, in which case a typical diameter is about 2.5 mm. Its cross-section can be any shape. Typically it is circular, square or rectangular. In the case of co-extruded tapes or yarns, the first layer (typically the core layer) is in direct contact with the second layer (typically the outer layer). The second layer may encompass the first layer in part or completely. In addition to the second layer, a third or even further PLA layer may be present, having a composition that is different from the other two layers, in particular with respect to functionality, softening temperature or crystallinity. The second and third (or even further) layers together may encompass in part or completely the first layer.

Unstretched PLA has a very low elongation at failure and tenacity, which is reflected in the poor energy absorption of a film or tape, injected or otherwise molded part made from such material. During stretching, PLA undergoes a transition from glassy to semi-crystalline due to the strain-induced alignment of the molecules. This is reflected by a change in colour of the tapes or films from transparent to white. This effect is displayed at different stretch ratios depending on the temperature and higher temperature stretching moves this effect to higher stretch ratios. With higher stretching, the tenacity keeps growing but the fracture toughness of the produced films or tapes goes down again. Uni- or bi-axially stretching below a total stretch ratio (SR) of 4 will produce films and tapes that are relatively weak and difficult to handle.

As the skilled person is well aware, by stretching a tape, film or yarn, it changes structurally, inter alfa in that the molecules (polymeric chains) are rearranged. This changed structure is reflected by an increased tensile strength and an increased elastic modulus (E-modulus). Thus the tensile strength and/or the E-modulus are in fact product features and can be used to characterize the tape, film or yarn of the invention. In accordance with the invention, products may be provided having a tensile strength of 150 MPa or more, preferably 240 MPa or more. The elongation at break is preferably higher than 7% but typically 7-25%. Preferably the E-modulus is 4.5 GPa or more, more preferably 6.5 GPa or more.

As a comparison, unstretched PLA tapes, films or yarns, typically have a tensile strength of about 60 MPa, an elongation at break of 4% and an E-modulus of about 3 GPa.

The state of the art for spinning-stretching of multifilament in a lab scale is currently over 1000 MPa and 10 GPa for strength and modulus, respectively as reported by Gupta et al. (Progress in Polymer Science, 32(2007)455-482). This compares well with the theoretical limits for this material, being the alpha polymorph of PLA the stiffest with an elastic modulus of 15 GPa. The beta polymorph of PLA has a lower modulus (7 GPa) and can be produced at higher temperatures. The alpha polymorph crystalline structure is believed to form an orthorhombic crystal lattice whereas the beta polymorph is known to form a trigonal structure.

The tapes, films or yarns of the present invention may be woven, for instance as a plain-weave fabric. This is an excellent configuration to improve the homogeneity of the final product in terms of mechanical properties. Other configurations, such as twill or satin weave, unidirectional aligned and compressed tapes or filament wound parts are also possible.

The woven fabric, due to its unique configuration, has a limit to its strength and elastic modulus which is below 50% of the tape in the machine direction. This is due to the fact that the fabric will be composed of tapes stretched both in the machine direction and transverse direction and off-plane orientation in the crimped transition zones. The properties in the transverse direction can be up to one or two orders of magnitude lower than in the machine direction due to the orthotropic alignment of the macromolecules. The minimum stiffness and strength obtainable are then 3 GPa and 75 MPa respectively, thus, using a woven PLA tape or yarn fabric will render a product with stiffness and strength comparable to those found in durable products as described in Table 1 below:

TABLE 1

| Material | Modulus (GPα) | Strength MPα) |
|---|---|---|
| Current embodiment | 3.0 | 75 |
| (plain weave fabric) | | |
| SAN (Styrene-acrylonitrile) | 3.7 | 75 |
| ABS (Acrylonitrile butadiene styrene) | 2.3 | 45 |
| PS (Polystyrene) | 3.3 | 50 |
| PC (Polycarbonate) | 2.4 | 70 |
| PBT (Polybutylene terephthalate) | 2.6 | 58 |

Some of the aforementioned materials have a low elongation at failure which makes them inherently fragile whereas the material here described has an elongation at failure in the range 7-25%, rendering it a tough material.

The E-modulus as used herein can be determined using methods known in the art. Unless stated otherwise, all values used herein are obtained using the method of standard test EN 10002.

Each layer of the tapes, films, yarns and the like of the invention are preferably made by either cast-film extrusion or by blown film extrusion. When two or more layers are used for this product, these are joined by coextrusion, viz. by passing the plasticized resin coming from two or more extruders, containing two or more different raw materials with varying thermal properties as described above, and extruding them simultaneously through a die in a layered configuration.

The total stretch ratio as used herein primarily refers to unidirectional stretching, in particular to stretching in the machine (longitudinal) direction. However, some transversal stretching can generally not be avoided, in particular when blow-film extrusion is carried out. In accordance with the present invention, the total stretch ratio in the machine direction (X) is more than 4, whereas the total stretch ratio in the direction transverse to the film (Y) is preferably less than of 1.5, so that the ratio of these stretch ratios (X/Y, the biaxial stretch aspect ratio) is 2.7 or more but preferably 4 or more.

In a preferred embodiment, a tape, film or yarn of the invention comprises one central layer having a Tm and an outer layer having a sealing temperature that is lower than that of Tm of the central layer. Preferably, according to this embodiment, the tape, film or yarn is of the ABA type, viz. a sandwiched structure, wherein “A” denotes the outer layer and “B” the core layer.

In another preferred embodiment, the tape, film or yarn according of the invention has an inner layer comprising semi-crystalline PLA and an outer layer comprising amorphous PLA. The inner layer, whilst mostly crystalline, can sustain temperatures high enough to melt the glue in the outer amorphous layer, without melting.

In another preferred embodiment, the tape, film or yarn according of the invention has a single layer comprising a crystalline PLA phase and an amorphous PLA phase. By using a carefully controlled heating process, the amorphous phase in the tape or yarn will melt or soften to act as a glue whilst the crystalline phase will remain unmodified.

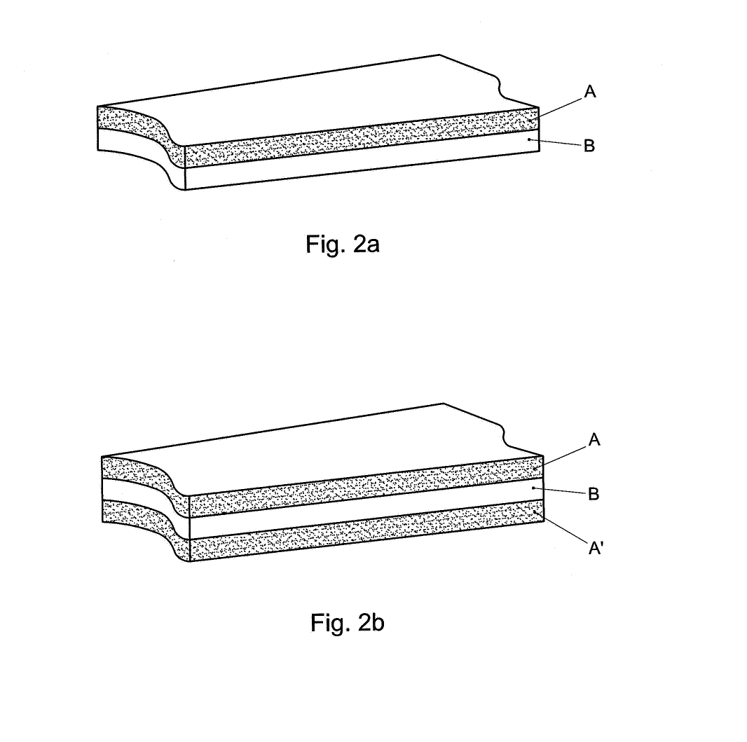

FIGS. 2a and 2b depict, schematically, tapes, films or yarns in accordance with the invention. FIG. 2a shows an embodiment in which layer A, having a seal initiation temperature that is lower than the melt temperature of layer B. The same applies for FIG. 2b, which shows an additional layer A′, which may be of the same composition as layer A (ABA type) or of another composition.

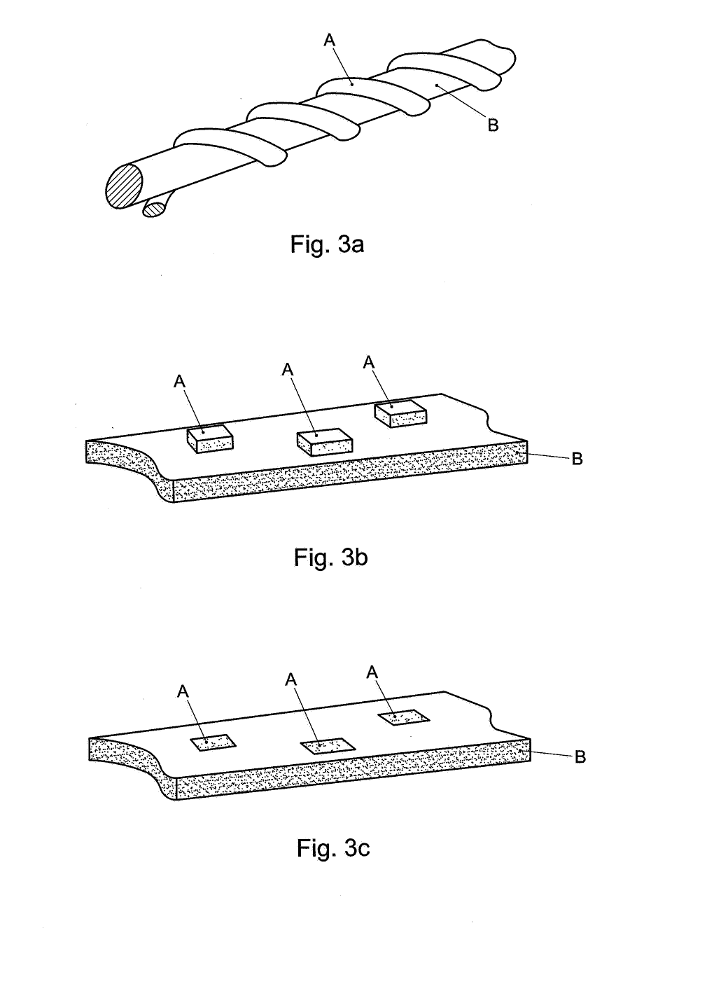

FIGS. 3a, 3b and 3c schematically show further possible variations of the tapes, films or yarns of the invention. The embodiment of FIG. 3a is a tape, film or yarn comprising a central core B which has wrapped around it a fiber-like element A, wherein layer A has again a seal initiation temperature that is lower than the melt temperature of layer B. In the embodiment depicted in FIG. 3b, the material having the lower seal initiation temperature is applied not as a continuous layer but rather as separate islands or phases, while still obtaining the benefits of the invention. In the embodiment of FIG. 3c, the phases A and B are applied such that only the surface of the resulting tape, film or yarn shows separate phases A and B, for instance by incorporating phase A into layer B.

Preferably PLA is used in one or more of the layers, preferably in all layers, which is enantiomerically enriched, preferably with the L-enantiomer being the major enantiomer, more preferably more than 85 wt % of the monomeric units making up the PLA is L-lactic acid, even more preferably more than 90 wt %, most preferably between 96-98 wt %. It was found that this improves the processability and mechanical properties. Alternatively, one or more of the phases can be replaced by a mixture of 50% L-lactic acid and 50% D-lactic acid. This mixture can form a stereo-complex compound with enhanced temperature resistance and mechanical properties.

WO-A-2004/103673 (Ward et al.), which document is incorporated herein by reference, describes a process for the production of a polymeric article. The technique described in this document may advantageously be used in accordance with the present invention, viz. by employing PLA. Thus according to this embodiment, the method of the present invention comprises the steps of: (a) forming a ply having successive layers, namely (i) a first layer made up of strands of a PLA material, in particular PLA containing at least a crystalline phase; (ii) a second layer of an amorphous PLA material or a PLA semi-crystalline material with a lower crystallinity than the first layer; (iii) a third layer made up of strands of a PLA material, in particular PLA containing at least a crystalline phase, wherein the first and third layer have a higher peak melting temperature than that of the sealing temperature as determined by ASTM F1921 of the second layer; (b) subjecting the ply to conditions of time, temperature and pressure sufficient to melt a proportion of the first layer and third layer; and to compact the ply; and (c) cooling the compacted ply. The resultant articles have good mechanical properties yet may be made at lower compaction temperatures than articles not employing the second layer, leading to a more controllable manufacturing process.

The PLA tapes, films or yarns of the invention may further comprise additives to improve processability or change optical properties. Preferably the tape, film or yarn is free or essentially free (i.e. typically containing less than 0.5 wt %) of plasticizers and will be composed of more than 95% of PLA.

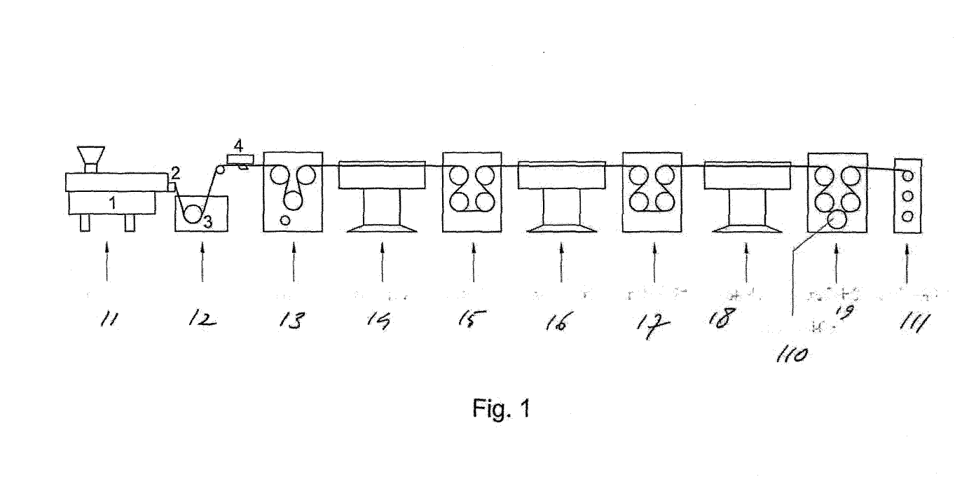

In a preferred embodiment, the tapes, films or yarns are produced using a setup as schematically depicted in FIG. 1.

With reference to FIG. 1, in one embodiment of the process of the invention the PLA raw material, usually in the form of pellets, is fed to two different extruders (Extruders A and B, 11), where it is forced through a single die 2 to obtain a coextruded product. Subsequently the material is cooled in cooling step 12 by feeding it over third roller 17 which is placed in a bath of water, having a temperature of typically 15-45° C. The material is then fed to slitter 4, where the tape is cut into two or more strips. A first stretching step is carried out by first feeding the material to first roller 13, then to a first oven 14, where it is heated to a temperature of typically 75-95° C., preferably 80-90° C., and then to second roller 15. By choosing the roller speed for second roller 15 higher than the roller speed for first roller 13, the PLA material is stretched. Subsequently, a second stretching step is carried out by first feeding the material to a second oven 16, where it is heated to a temperature of typically 95-170° C., preferably 100-110° C., and then to third roller 17, wherein the roller speed for third roller 17 is chosen higher than the roller speed for second roller 15. Subsequently, a relaxation step is carried out by first feeding the material to a third oven 18, where it is heated at a temperature of typically 90-150° C., and then to fourth roller 19, wherein the roller speed for fourth roller 19 is chosen lower than the roller speed for third roller 17. This step reduces or completely avoids shrinkage of the tapes, films or yarns during subsequent operations. The product obtained can then be fibrillated by fibrillator 110 to give it a softer feel for textile applications at the expense of a reduction in mechanical properties. Finally the product is winded on reels in winding step 111.

In a variation from the process described, the slit film can be stretched in a single operation, using a temperature between 75° C. and 170° C. The choice of temperature will depend on the stiffness and tenacity sought. A lower temperature will render a higher elastic modulus which will be reduced with increasing temperature. An increase in temperature will improve the tenacity until reaching a plateau and then decreasing again. The maximum stretch ratio attainable in a single stretch operation can be lower than that obtainable with a double stretch operation. The stability of the process can be also compromised. This process can also contain a relaxation step and fibrillation operation.

The raw PLA materials may in accordance with the invention be coextruded in an AB or ABA configuration, where A is for instance an amorphous, functional or adhesive layer and B is for instance a semi-crystalline or load-bearing layer. Subsequently, the material is cooled by feeding it over third roller 17 which is placed in a bath of water, having a temperature of typically 15-45° C. The material is then fed to slitter 4, where the tape is cut into two or more strips. A first stretching step is carried out by first feeding the material to first roller 13, then to a first oven, where it is heated to a temperature of typically 75-95° C., preferably 80-90° C., and then to second roller 15. By choosing the roller speed for second roller 15 higher than the roller speed for first roller 13, the PLA-coextruded material is stretched. Subsequently, a second stretching step is carried out by first feeding the material to a second oven, where it is heated to a temperature of typically 95-170° C., preferably 100-110° C., and then to third roller 17, wherein the roller speed for third roller 17 is chosen higher than the roller speed for second roller 15. Subsequently, a relaxation step may be carried out by first feeding the material to a third oven, where it is heated at a temperature of typically 90-150° C., and then to fourth roller 19, wherein the roller speed for fourth roller 19 is chosen lower than the roller speed for third roller 17. This step is in order to reduce or completely avoid shrinkage of the tapes or yarns during subsequent operations. The product obtained can then be fibrillated to give it a softer feel for textile applications at the expense of a reduction in mechanical properties. Finally the product is wound onto tubes to make bobbins for subsequent processing.

Preferably, godet rollers are used for the first, second and third rollers. Preferably, after the film has been formed from the extruder dye, it is fed to a cooling bath, typically a water-filled bath at a relatively low temperature of 15-45° C., preferably about 20-35° C. This “freezes” the film and prevents so-called neck-in of the film.

Preferably, the extruder is purged before stretching with polyethylene (PE) having a melt flow index of at least 2, preferably at least 5, e.g. around 8 or polypropylene (PP) having a melt flow index of at least 2, preferably at least 5, e.g. around 8.

tape, film or yarn of the invention can also be prepared by blown film extrusion (also referred to as the tubular film extrusion) or blown film co-extrusion. Blown film extrusion is a process known per se. The process involves extrusion of a plastic through a circular die, followed by “bubble-like” expansion. In this way, tubing (both flat and gusseted) can be produced in a single operation. The film width and thickness can be controlled by factors such as the volume of air in the bubble (air flow rate), the output of the extruder and the speed of the haul-off. Biaxial orientation of the film can be controlled by transport speed and air flow rate. The material produced via this route can be stretched following the same procedure as described above.

tapes, films or yarns of the present invention have an excellent elongation to break, typically of 7-20%, preferably about 10%.

### REFERENCE EXAMPLE

A PLA tape was processed in a setup as schematically depicted in FIG. 1.

PLA pellets grade 4032D from NatureWork, having a D-lactide content of 4% were fed to extruder B. The extruder has an length over diameter ratio of 30:1 and a general-purpose screw.

The temperature was set to 40° C. in the hopper section and a standard temperature profile was set from 180° C. in the first section of the extruder to 200° C. in the last section and adapter with a step-wise increase. The extrusion head was set at 190° C.

The chill roll (3) in FIG. 1 was set at 6.8 m/min. The first haul off after the slitting unit was set to 7.3 m/min. Oven 1 was set at 80° C. The second godet in haul-off 2 was set at 39 m/min. The total stretch ratio was 5.2.

### Example 1

Two different types of PLA were processed in a setup as schematically depicted in FIG. 1.

PLA pellets grade 4060D and 4032D from NatureWork, having a D-lactide content of 12% and 4% respectively were fed to two extruders A and B, respectively. The extruders have an L/D ratio of 30:1 and general-purpose screws. Extruder A operated at a speed of 20 revolutions per minutes (rpm), resulting in an output of 10 kg/min. Extruder B operated at a speed of 30 rpm, resulting in an output of 78 kg/min. The ratio of PLA from extruder A to that of extruder B was 87/13.

The temperature was set to 40° C. in the hopper section and a standard temperature profile was set from 180° C. in the first section of the extruder to 200° C. in the last section and adapter with a step-wise increase. The extrusion head was set at 190° C.

The chill roll (3) in FIG. 1 was set at 6.8 m/min. The first haul off after the slitting unit was set to 7.3 m/min. Oven 1 was set at 80° C. The second godet in haul-off 2 was set at 39 m/min. The total stretch ratio was 5.2.

A co-extruded tape with a layout ABA was obtained having a runnage of 1190 denier, a tenacity of 2.5 gf/den and a strain at failure of 17%. These results are also given in Table 2.

### Examples 2-6

Example 1 was repeated while the settings for the speeds of the extruders and the setting for the second godet were varied, resulting in different amounts of PLA for each layer and different stretch ratios, respectively, as indicated in Table 2. The resulting properties are also given in Table 2.

TABLE 2

| | RPM | RPM | 2nd | Runnage | Tenacity | Strain at | |
|---|---|---|---|---|---|---|---|
| Example | A | B | godet | [denier] | [gf/den] | failure [%] | Remarks |
| Reference | 0 | 30 | 39 | 990 | 2.6 | 18 | SR 5.2 |
| 1 | 20 | 30 | 39 | 1190 | 2.5 | 17 | SR 5.2 - ratio of |
| | | | | | | | layers A:B = 87:13 |
| 2 | 20 | 30 | 42 | 1090 | 2.2 | 9.1 | SR 5.6 |
| 3 | 20 | 30 | 45 | 1080 | 2.2 | 7.3 | SR 6.0 |
| 4 | 20 | 30 | 48 | 980 | 2.2 | 5.8 | SR 6.4 |
| 5 | 30 | 30 | 42 | 1430 | 2.1 | 14 | SR 5.2 - ratio of |
| | | | | | | | layers A:B = 82:18 |
| 6 | 40 | 30 | 42 | 1440 | 2.1 | 14 | SR 5.2 - ratio of |
| | | | | | | | layers A:B = 77:23 |

The elastic modulus was 6.5 GPa for all of the tested samples. A higher stretch ratio did not give a higher tenacity nor elastic modulus pointing to the optimum processing conditions being at a different oven temperature or stretch ratio. The only part of the stress-strain curve that was modified when increasing the SR was after the yield point which reinforces the previous point. Since the higher SRs gave a lower elongation, and hence toughness, there was no increase in the tenacity due to earlier brittle failure of the probes.

Samples from Examples 1, 5 and 6 were tested for sealing. Example 1 did not display any visible sealing up to 130° C. Even at this high temperature, there was no visible melting or softening of the B layer, though the shrinkage was extremely high.

Examples 5 and 6 showed good sealing behavior from 90° C. upwards.

Example 6 was tested with regards to the reduction in elastic modulus with temperature as described in table 3 below.

TABLE 3

| Temperature | Chord modulus (2-3% deformation) |
|---|---|
| 23° C. | 6.50 GPa |
| 40° C. | 3.86 GPa |
| 50° C. | 2.23 GPa |
| 70° C. | 1.57 GPa |

### Examples 7-8

Example 1 was repeated while the settings for the speeds of the extruders and the setting for the second godet were kept constant, and different stretch ratios with a second stretch operation, respectively, as indicated in Table 4. The resulting properties are also given in Table 4.

TABLE 4

| | RPM | RPM | 2nd | Second | 3^{rd} | runnage | Tenacity | Strain at | |
|---|---|---|---|---|---|---|---|---|---|
| Example | A | B | godet | oven | godet | [denier] | [gf/den] | failure [%] | Remarks |
| 1 | 20 | 30 | 39 | — | — | 1190 | 2.5 | 17 | SR 5.2 |
| 7 | 20 | 30 | 39 | 110° C. | 42 | 1080 | 2.6 | 8.7 | SR 5.6 |
| 8 | 20 | 30 | 39 | 110° C. | 45 | 1070 | 2.7 | 7.1 | SR 6.0 |

The elastic modulus was slightly higher for samples 7 and 8, with 6.7 GPa and 6.8 GPA versus 6.5 GPA average of the single stretch operation examples. A double stretch operation brings also a small increase in the tenacity of the intermediate product when compared to the single stretch operation, being the main improvement in the stability of the production process.

1. A tape, film or yarn comprising a first layer and a second layer, both based on PLA, wherein said second layer is coextruded on said first layer, wherein the seal initiation temperature and/or peak melt temperature of said second layer is lower than the seal initiation temperature and/or the peak melt temperature of said first layer.

2. A tape, film or yarn comprising a first layer and a second layer, both based on PLA, wherein said second layer is coextruded on said first layer, wherein the Vicat softening point of said second layer is lower than the Vicat softening point of said first layer.

3. The tape, film or yarn according to claim 1, which comprises a further layer that is coextruded on said first layer, wherein a tape, film or yarn of the ABA type is formed.

4. The tape, film or yarn according to claim 1, wherein the first layer, comprises semi-crystalline PLA and the second layer, comprises amorphous PLA or PLA with a lower crystallinity than the first layer.

5. The tape, film or yarn according to claim 1, which is stretched to a total stretch ratio of at least 4.

6. The tape, film or yarn according to claim 1, which is stretched in one or more stretching stages.

7. An object prepared by heat treatment of a woven or non-woven film comprising tapes, films or yarns according to claim 1.

8. The object according to claim 7 having a tensile strength of 75 MPa or more.

9. The object according to claim 7, having an elongation at break of 7-25%.

10. The object according to claim 7 having an E-modulus of 2.5 GPa or more.

11. The object according to claim 7, which is biodegradable.

12. The object according to claim 7, which is compostable.

13. The method of claim 4 wherein the first layer is an inner layer and the second layer is an outer layer.

14. The object according to claim 7 having a tensile strength of 120 MPa or more.

15. The object according to claim 7, having an elongation at break of 10-15%.

16. The object according to claim 7 having an E-modulus of 3.5 GPa or more.
